(19) United States
(12) Patent Application Publication
(10) Pub. No.: US 2017/0211161 A1
(43) Pub. Date: Jul. 27, 2017

(54) NON-ORIENTED ELECTRICAL STEEL SHEET AND MANUFACTURING METHOD THEREOF

(71) Applicant: JFE STEEL CORPORATION, Chiyoda-ku, Tokyo (JP)

(72) Inventors: Tadashi NAKANISHI, Chiyoda-ku, Tokyo (JP); Hiroaki NAKAJIMA, Chiyoda-ku, Tokyo (JP); Tomoyuki OKUBO, Chiyoda-ku, Tokyo (JP); Yoshihiko ODA, Chiyoda-ku, Tokyo (JP)

(73) Assignee: JFE STEEL CORPORATION, Chiyoda-ku, Tokyo (JP)

(21) Appl. No.: 15/500,435

(22) PCT Filed: Aug. 13, 2015
(86) PCT No.: PCT/JP2015/004046

§ 371 Date: Jan. 30, 2017

(30) Foreign Application Priority Data
Aug. 21, 2014 (JP) 2014-168691

(51) Int. Cl. C21D 8/12; C22C 38/60; C22C 38/06; H01F 1/147; C22C 38/00; C22C 38/16; C22C 38/02; C21D 6/00; C22C 38/04

(52) U.S. Cl. CPC C21D 8/1272; C21D 8/1222; C21D 8/1233; C21D 6/008; C22C 38/60; C22C 38/06; C22C 38/04; C22C 38/008; C22C 38/16; C22C 38/002; C22C 38/001; C22C 38/02; H01F 1/14791; H01F 1/14775

(57) ABSTRACT

A non-oriented electrical steel sheet with excellent recyclability whose magnetic property is prevented from becoming unstable in the case of reducing the Al content in order to reuse the non-oriented electrical steel sheet as iron scrap is provided. The non-oriented electrical steel sheet has a chemical composition containing, in mass %: C: 0.0050% or less; Si: 1.0% or more and 4.0% or less; Mn: 0.10% or more and 3.0% or less; Sol. Al: less than 0.0050%; P: more than 0.01% and 0.20% or less; S: 0.0050% or less; N: 0.0050% or less; Cu: 0.02% or more and less than 0.10%; and Ca: 0.0005% or more and 0.0100% or less, with a balance being Fe and incidental impurities.

### TECHNICAL FIELD

The disclosure relates to a non-oriented electrical steel sheet mainly used as an iron core material of an electrical device, in particular a non-oriented electrical steel sheet with excellent recyclability from which hindrances to recycling have been eliminated, and a manufacturing method thereof.

### BACKGROUND

Growing concerns over the depletion of the earth's resources and the increase of waste have promoted the movement of recycling resources in various fields. In the iron and steel industry, various types of iron scrap such as vehicles, washing machines, and air conditioners have been utilized as part of steelmaking raw materials, and the amount of iron scrap is expected to further increase in the future. An increase in the amount of scrap in steelmaking means better recyclability. However, since scrap contains Cu and the like that have conventionally been regarded as harmful, there is a problem of degraded quality of steel products.

Consciousness about energy conservation has also been growing to preserve the earth's resources. In the field of motors, motors such as those used for home air conditioners are required to consume less power to reduce energy loss. Thus, non-oriented electrical steel sheets used as iron core materials of motors are also required to have high performance, and non-oriented electrical steel sheets with low iron loss to reduce the iron loss of motors and non-oriented electrical steel sheets with high magnetic flux density to reduce the copper loss of motors are in demand.

Consumers utilizing, as raw materials of castings, scrap generated when punching iron core materials have been on the increase recently, too.

To ensure the castability of scrap, the Al content of steel sheets needs to be reduced to less than 0.05%. If the Al content is 0.05% or more, blowholes tend to occur in castings.

Regarding a non-oriented electrical steel sheet with reduced Al content, JP 4126479 B2 (PTL 1) describes that, when the Al content is 0.017% or less and preferably 0.005% or less, the texture is improved to enhance the magnetic flux density. Meanwhile, PTL 1 also describes that such an ultra low Al material degrades in iron loss and has unstable magnetic property.

### CITATION LIST

### Patent Literatures

PTL 1: JP 4126479 B2

### SUMMARY

### Technical Problem

As mentioned above, a problem when recycling a non-oriented electrical steel sheet lies in that the magnetic property becomes unstable in the case of reducing the Al content in order to reuse the non-oriented electrical steel sheet as iron scrap. It could therefore be helpful to provide a non-oriented electrical steel sheet with excellent recyclability and a manufacturing method thereof.

### Solution to Problem

As a result of extensive research for a non-oriented electrical steel sheet with excellent recyclability, we discovered that the magnetic property varies significantly in the case where Cu derived from the use of scrap material and the like is mixed into an ultra low Al material, as described later. We also discovered that adding Ca to such steel in which Cu has been mixed into the ultra low Al material is very effective in suppressing the variation of the magnetic property. The disclosure is based on the aforementioned discoveries.

We provide the following:

1. A non-oriented electrical steel sheet having a chemical composition containing (consisting of), in mass %: C: 0.0050% or less; Si: 1.0% or more and 4.0% or less; Mn: 0.10% or more and 3.0% or less; Sol. Al: less than 0.0050%; P: more than 0.01% and 0.20% or less; S: 0.0050% or less; N: 0.0050% or less; Cu: 0.02% or more and less than 0.10%; and Ca: 0.0005% or more and 0.0100% or less, with a balance being Fe and incidental impurities.

2. The non-oriented electrical steel sheet according to the foregoing 1, wherein the chemical composition further contains one or two selected from Sn and Sb: 0.01 mass % or more and 0.1 mass % or less in total.

3. A manufacturing method of a non-oriented electrical steel sheet, including: hot rolling a slab having a chemical composition containing (consisting of), in mass %: C: 0.0050% or less; Si: 1.0% or more and 4.0% or less; Mn: 0.10% or more and 3.0% or less; Sol. Al: less than 0.0050%; P: more than 0.01% and 0.20% or less; S: 0.0050% or less; N: 0.0050% or less; Cu: 0.02% or more and less than 0.10%; and Ca: 0.0005% or more and 0.0100% or less, with a balance being Fe and incidental impurities; pickling an obtained hot rolled sheet without annealing, and then cold rolling the sheet; and final annealing the cold rolled sheet, wherein after finish rolling in the hot rolling, the hot rolled sheet is coiled at a temperature of 650° C. or more.

4. The manufacturing method of a non-oriented electrical steel sheet according to the foregoing 3, wherein the chemical composition further contains one or two selected from Sn and Sb: 0.01 mass % or more and 0.1 mass % or less in total.

### Advantageous Effect

It is thus possible to stably provide a non-oriented electrical steel sheet with excellent recyclability which significantly contributes to the protection of the environment and resources on a global scale.

### BRIEF DESCRIPTION OF THE DRAWINGS

In the accompanying drawings:

FIGS. 1A and 1B are graphs illustrating the influence of Cu on the magnetic property in an ultra low Al material;

FIGS. 2A and 2B are graphs illustrating the influence of Cu on the magnetic property in an Al added material;

FIGS. 3A and 3B are graphs illustrating the influence of Cu on the magnetic property in an ultra low Al material to which Ca is added; and

FIGS. 4A and 4B are graphs illustrating the influence of Cu on the magnetic property in an Al added material to which Ca is added.

### DETAILED DESCRIPTION

Detailed description is given below based on experimental results.

The representations “%” and “ppm” regarding each component are “mass %” and “mass ppm”, unless otherwise noted. The magnetic property was evaluated as follows: Epstein test pieces were collected in the rolling direction (L) and the direction orthogonal to the rolling direction (C), and measurement was performed by Epstein's method described in JIS C2550, to evaluate the magnetic property based on B₅₀ (magnetic flux density with a magnetizing force of 5000 A/m) and W_{15/50} (iron loss when excited with a magnetic flux density of 1.5 T and a frequency of 50 Hz).

First, the following experiment was conducted to determine the influence of ultra low Al content in a non-oriented electrical steel sheet on the magnetic property.

Steel having a steel composition containing C: 0.002%, Si: 1.6%, Mn: 0.5%, P: 0.04%, Al: 0.0005% or less, N: 0.002%, and S: 0.002% as an ultra low Al material was tapped for 8 charges, and hot rolled to 2.8 mm in sheet thickness. After pickling the hot rolled sheet, the hot rolled sheet was cold rolled to 0.5 mm in sheet thickness, and subjected to final annealing of 1000° C.×10 s in a 20%H₂-80%N₂ atmosphere. As a result of studying the magnetic property of the obtained material by making test pieces per charge, we found out that the magnetic property varied significantly among the charges. Moreover, component analysis showed that a material with degraded magnetic property contained 0.02% or more Cu which was higher than those of other materials, suggesting that the magnetic property degraded due to fine Cu precipitation or the like.

Since scrap sources are, for example, electrical appliances such as washing machines or air conditioners, Cu of conductors is incidentally contained in scrap. Given that the use ratio of scrap as steelmaking raw materials has increased in recent years, it appears that Cu derived from scrap was mixed in the material with degraded magnetic property.

We accordingly studied the influence of Cu on the magnetic property. Steel containing C: 0.002%, Si: 1.6%, Mn: 0.5%, P: 0.04%, Al: 0.0005% or less, N: 0.002%, and S: 0.002% as a ultra low Al material and steel containing C: 0.002%, Si: 1.3%, Mn: 0.5%, P: 0.04%, Al: 0.3%, N: 0.002%, and S: 0.002% as an Al added material for comparison were each obtained by steelmaking while being changed in the range of Cu: 0.005% to 0.04% (no Ca added to both materials). The steel was then hot rolled to 2.8 mm in sheet thickness. After pickling the hot rolled sheet, the hot rolled sheet was cold rolled to 0.5 mm in sheet thickness, and subjected to final annealing of 1000° C.×10 s in a 20%H₂-80%N₂ atmosphere. The results of studying the respective magnetic properties of these final annealed sheets are illustrated in

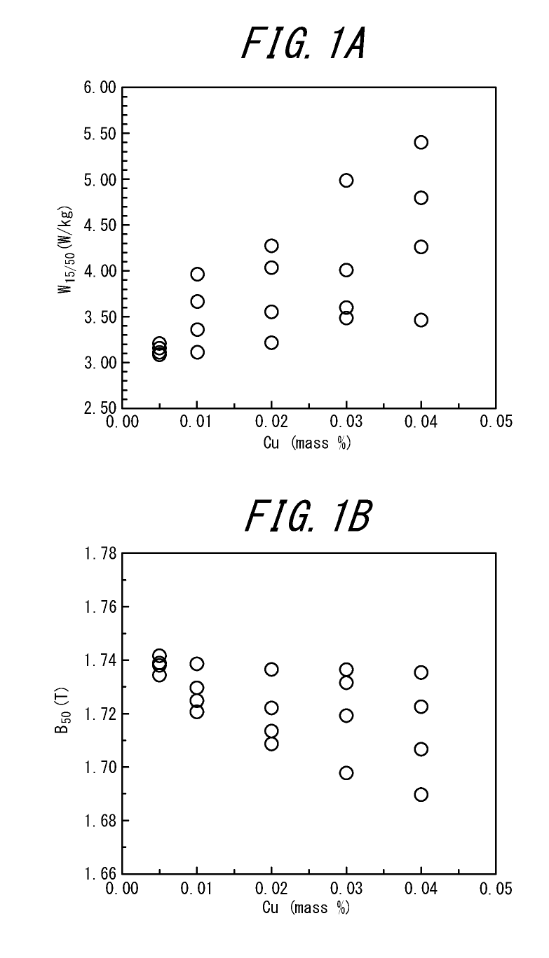

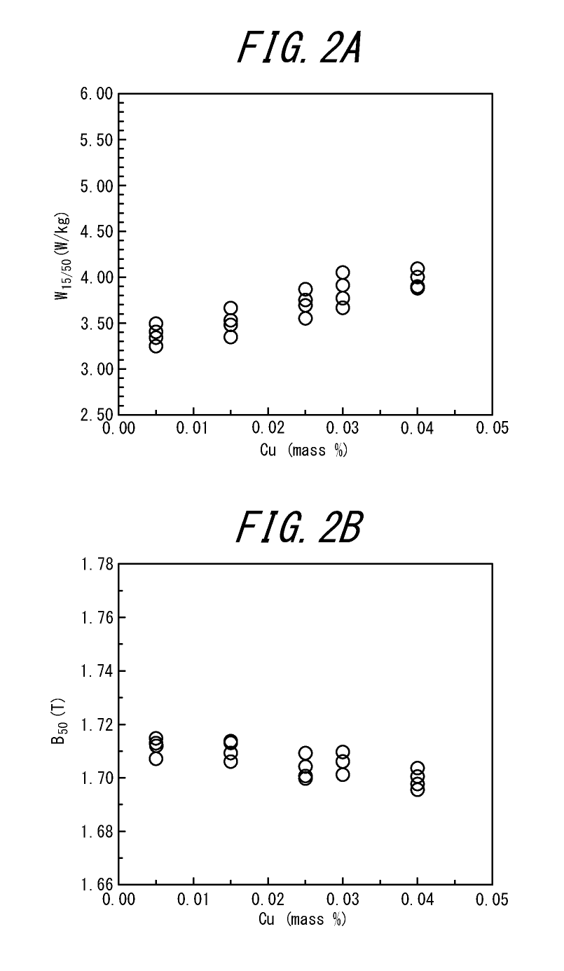

FIGS. 1A and 1B (ultra low Al+Ca not added) and FIGS. 2A and 2B (Al added+Ca not added). FIGS. 1A and 1B respectively illustrate the iron loss and magnetic flux density measurement results, and FIGS. 2A and 2B respectively illustrate the iron loss and magnetic flux density measurement results.

In the Al added material illustrated in FIGS. 2A and 2B, the magnetic property degradation due to the Cu increase was relatively small. In the ultra low Al material illustrated in FIGS. 1A and 1B, on the other hand, the magnetic property varied significantly as Cu increased, and the most degraded magnetic property with the same Cu amount was very poor. When Cu was about 0.01%, however, the ultra low Al material had better magnetic property than the Al added material. Thus, the ultra low Al material has the potential for excellent property, but is problematic in that its magnetic property degrades or varies significantly with an increase of Cu.

The reason for this is not clear, but is believed as follows: Since the ultra low Al material has no element for coarsening nitride, the nitride becomes fine, and some kind of interaction between the fine nitride and the Cu sulfide leads to property variation. Favorable property was actually obtained when sufficiently reducing Cu in the ultra low Al material. Hence, reducing Cu in the ultra low Al material can be a means for stabilizing the magnetic property. To do so, however, the use ratio of iron scrap needs to be decreased, against the recent trend to protect the environment and resources.

We accordingly considered using Ca to render Cu harmless.

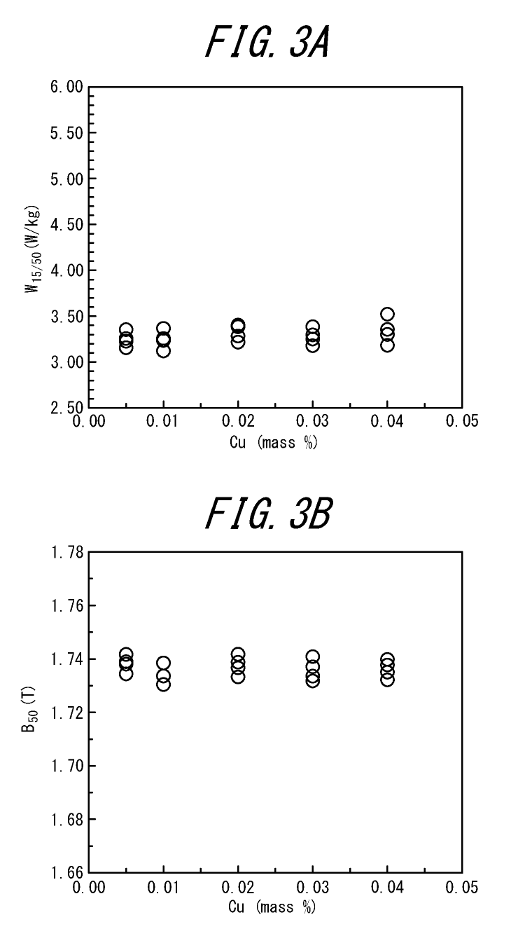

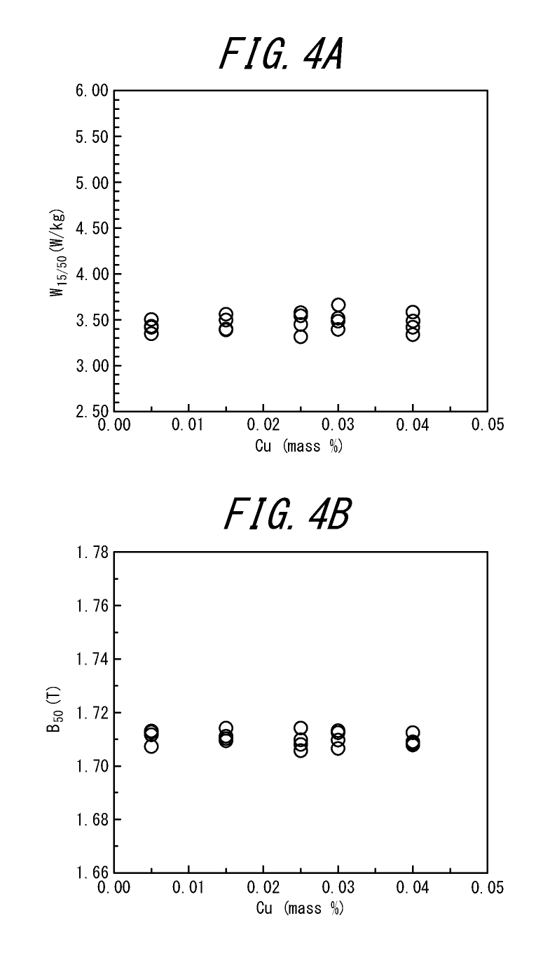

Steel containing C: 0.002%, Si: 1.6%, Mn: 0.5%, P: 0.04%, Al: 0.0005% or less, N: 0.002%, S: 0.002%, and Ca: 0.003% as an ultra low Al material (Ca added) and steel containing C: 0.002%, Si: 1.3%, Mn: 0.5%, P: 0.04%, Al: 0.3%, N: 0.002%, S: 0.002%, and Ca: 0.003% as an Al added material (Ca added) for comparison were each obtained by steelmaking while being changed in the range of Cu: 0.005% to 0.04%. The steel was then hot rolled to 2.8 mm in sheet thickness. After pickling the hot rolled sheet, the hot rolled sheet was cold rolled to 0.5 mm in sheet thickness, and subjected to final annealing of 1000° C.×10 s in a 20%H₂-80%N₂ atmosphere. The results of studying the respective magnetic properties of these final annealed sheets are illustrated in FIGS. 3A and 3B (ultra low Al+Ca added) and FIGS. 4A and 4B (Al added+Ca added).

As illustrated in FIGS. 3A, 3B, 4A and 4B, the degradation or variation of the magnetic property due to the Cu increase was suppressed by adding Ca. This effect was very remarkable in the ultra low Al material illustrated in FIGS. 3A and 3B, which had better magnetic property than the Al added material regardless of the amount of Cu.

Based on the aforementioned discoveries, it is possible to provide a non-oriented electrical steel sheet with excellent recyclability that, even though being an ultra low Al material, ensures favorable magnetic property by regulating especially the amounts of Al, Cu, and Ca.

The reasons for limiting the steel components to the aforementioned composition range are described below.

C: 0.0050% or less

C degrades iron loss property, and so the C content is desirably as low as possible. If the C content is more than 0.0050%, the iron loss increases significantly. The C content is therefore limited to 0.0050% or less. Since the C content is desirably as low as possible, its lower limit need not be particularly limited. Given that reducing the content to less than 0.0003% in industrial-scale production requires considerable cost, however, the lower limit is preferably 0.0003%.

Si: 1.0% or more and 4.0% or less

Si has an effect of increasing electrical resistance to reduce iron loss, and so its lower limit is 1.0%. If the Si content is more than 4.0%, rollability decreases. The Si content is therefore limited to 4.0% or less. The Si content is preferably 1.5% to 3.3%.

Al: less than 0.0050%

In terms of utilizing scrap by consumers, the Al content is recommended to be less than 0.05% to ensure castability from scrap raw materials. In the disclosure, the Al content needs to be further reduced to less than 0.0050% in order to improve the texture and enhance the magnetic flux density. The Al content is therefore less than 0.0050%. The Al content is preferably 0.0020% or less.

P: more than 0.01% and 0.20% or less

P is an element that, in a small amount, is useful to improve hardness. Since optimal hardness differs among consumers, P is added as appropriate in the range of more than 0.01%. Meanwhile, excessively adding P causes lower rollability, and so the P content is limited to 0.20% or less. The P content is preferably 0.03% to 0.10%.

N: 0.0050% or less

N degrades the magnetic property as with the aforementioned C, and so the N content is limited to 0.0050% or less. Since the N content is desirably as low as possible, its lower limit need not be particularly limited.

S: 0.0050% or less

S forms precipitates or inclusions and degrades the magnetic property of the product, and so the S content is desirably as low as possible. To suppress magnetic property degradation, the S content is limited to 0.0050% or less. Since the S content is desirably as low as possible, its lower limit need not be particularly limited.

Mn: 0.10% or more and 3.0% or less

Mn is an element effective in increasing electrical resistance to reduce iron loss, as with Si. To prevent hot shortness, the Mn content needs to be 0.10% or more. If the Mn content is more than 3.0%, however, a decrease in saturation magnetic flux density leads to a decrease in magnetic flux density. The upper limit is therefore 3.0%. The Mn content is preferably 0.20% to 1.0%.

Ca: 0.0005% or more and 0.0100% or less

In the disclosure, the material has high Cu content and extremely low Al content. Accordingly, Ca is added to stabilize the magnetic property. If the Ca content is less than 0.0005%, the effect is not sufficient. If the Ca content is more than 0.0100%, Ca oxide increases and causes higher iron loss. The Ca content is therefore 0.0005% or more and 0.0100% or less. The Ca content is preferably 0.001% or more and 0.005% or less.

Cu: 0.02% or more and less than 0.1%

The disclosure is intended to maximize the scrap ratio of steelmaking raw materials, to promote recycling of resources. In the case where the scrap ratio is increased, the raw material of the non-oriented electrical steel sheet contains 0.02% or more Cu. This is because scrap sources are, for example, electrical appliances such as washing machines or air conditioners, and so Cu of conductors is incidentally contained in scrap. If the Cu content is 0.1% or more, however, it is difficult to prevent property degradation even when Ca is added. The upper limit is therefore less than 0.1%.

In addition to the basic components described above, one or two selected from Sn and Sb may be added so that their total content is 0.01% or more and 0.1% or less, according to need.

Sn, Sb: 0.01% or more and 0.1% or less in total

Sn and Sb both have an effect of improving the texture and enhance the magnetic property. One or both of Sn and Sb may be added to achieve this effect. In either case, the total content is preferably 0.01% or more. If Sn and/or Sb are added excessively, however, the steel becomes brittle and sheet fractures or scabs during steel sheet manufacturing increase. Accordingly, whether one or both of Sn and Sb are added, the total content is preferably 0.1% or less. The total content is more preferably 0.02% to 0.08%.

The balance other than the components described above is iron and incidental impurities. Examples of the incidental impurities include V 0.004%, Nb 0.004%, B 0.0005%, Ni 0.05%, Cr 0.05%, and Ti 0.002%.

A manufacturing method according to the disclosure is described below.

When manufacturing a non-oriented electrical steel sheet according to the disclosure, the coiling temperature after hot rolling needs to be regulated in the case where hot band annealing is omitted. Except this, the manufacturing method can be realized using steps and lines used for typical non-oriented electrical steel sheets.

For example, steel having a predetermined chemical composition obtained by steelmaking using a converter, an electric heating furnace, or the like is subjected to secondary refining in a degassing line, and casted and hot rolled. Hot band annealing after hot rolling may be performed but is not essential. The annealing temperature in the case of performing hot band annealing is preferably 800° C. or more in terms of sufficient recrystallization, and preferably 1200° C. or less in terms of manufacturing cost. To reduce manufacturing cost, omitting hot band annealing is more advantageous. Steps such as pickling, cold rolling, final annealing, and insulating coating then follow to manufacture the non-oriented electrical steel sheet.

In the case of omitting hot band annealing, the coiling temperature after hot rolling needs to be 650° C. or more. If the steel sheet before cold rolling has not sufficiently recrystallized, ridging occurs or the magnetic property degrades. Accordingly, in the case of omitting hot band annealing, the coiling temperature needs to be 650° C. or more to facilitate recrystallization. The coiling temperature is preferably 670° C. or more.

In the case of performing hot band annealing, on the other hand, the coiling temperature need not be 650° C. or more.

The thickness of the hot rolled sheet is not particularly limited, but is preferably 1.5 mm to 3.0 mm, and more preferably 1.7 mm to 2.8 mm. If the thickness is less than 1.5 mm, hot rolling troubles increase. If the thickness is more than 3.0 mm, cold rolling reduction increases and the texture degrades. The thickness of the cold rolled sheet is not particularly limited, but is preferably 0.20 mm to 0.50 mm. If the thickness is less than 0.20 mm, productivity decreases. If the thickness is more than 0.50 mm, the iron loss reduction effect is low.

The aforementioned cold rolling may be warm rolling with a sheet temperature of about 200° C. The soaking temperature in the aforementioned final annealing which follows is preferably 700° C. or more and 1150° C. or less. If the soaking temperature in the annealing is less than 700° C., there is a possibility of not only recrystallization being insufficient and causing significant degradation in magnetic property but also the sheet shape adjustment effect by continuous annealing being insufficient. If the soaking temperature is more than 1150° C., on the other hand, there is a possibility of crystal grains being extremely coarsened and causing an increase in iron loss especially in a high frequency range.

### EXAMPLES

Hot metal was blown in a converter and then degassed to be adjusted to each chemical composition shown in Table 1. After this, the metal was cast into a slab using a continuous casting machine, and the slab was heated at 1120° C. for 1 hour and then hot rolled to 2.8 mm in sheet thickness. The finisher delivery temperature in the hot rolling was 900° C., and coiling was performed at 680° C. After the hot rolling, the hot rolled sheet was pickled without hot band annealing, cold rolled to 0.50 mm in sheet thickness, and final annealed at 980° C. for 10 seconds.

Here, for steel samples F and C2, the coiling temperature after the hot rolling was 550° C. Moreover, for steel sample C2, hot band annealing with a soaking temperature of 1000° C. and a soaking time of 30 seconds was performed by continuous annealing, after the hot rolling. Furthermore, steel sample H cracked during the hot rolling, and so the steps after the hot rolling were not performed on steel sample H. In the subsequent cold rolling, steel samples M and G fractured and steel sample F developed ridging, and so the steps after the cold rolling were not performed on these steel samples.

The magnetic property of each obtained product sheet was studied. The magnetic property was evaluated as follows: Epstein test pieces were collected in the rolling direction (L) and the direction orthogonal to the rolling direction (C), and measurement was performed by Epstein's method described in JIS C2550, to evaluate the magnetic property based on B₅₀ (magnetic flux density with a magnetizing force of 5000 A/m) and W₁₀₁₄₀₀ (iron loss when excited with a magnetic flux density of 1.0 T and a frequency of 400 Hz).

The results are shown in Table 1.

TABLE 1

| | | | | | | | | | | | | Magnetic property | | |
|---|---|---|---|---|---|---|---|---|---|---|---|---|---|---|
| Steel | | | | | | | | | | | | of product sheet | | |
| sample | Chemical composition (mass %) | | | | | | | | | | | W_{15/50} | B₅₀ | |
| ID | C | Si | Mn | Sol.Al | P | S | N | Cu | Sn | Sb | Ca | (W/kg) | (T) | Remarks |
| A | 0.0018 | 0.85 | 0.21 | 0.0011 | 0.08 | 0.0015 | 0.0021 | 0.03 | 0.037 | — | 0.0031 | 5.30 | 1.741 | Comparative Example |
| B | 0.0019 | 1.27 | 0.23 | 0.0012 | 0.09 | 0.0017 | 0.0017 | 0.02 | 0.041 | — | 0.0029 | 3.98 | 1.739 | Example |
| C | 0.0015 | 1.61 | 0.42 | 0.0009 | 0.02 | 0.0015 | 0.0018 | 0.04 | 0.038 | — | 0.0032 | 3.42 | 1.738 | Example |
| D | 0.0021 | 1.63 | 0.38 | 0.0001 | 0.11 | 0.0014 | 0.0022 | 0.04 | 0.035 | — | 0.0025 | 3.38 | 1.741 | Example |
| E | 0.0020 | 2.13 | 0.53 | 0.0004 | 0.08 | 0.0018 | 0.0017 | 0.03 | 0.032 | — | 0.0033 | 2.75 | 1.722 | Example |
| F | 0.0018 | 2.15 | 0.52 | 0.0002 | 0.07 | 0.0015 | 0.0020 | 0.04 | 0.031 | — | 0.0029 | Ridging after | | Comparative Example |
| | | | | | | | | | | | | cold rolling | | |
| G | 0.0019 | 4.05 | 0.65 | 0.0011 | 0.08 | 0.0022 | 0.0022 | 0.04 | 0.041 | — | 0.0030 | Cracking during | | Comparative Example |
| | | | | | | | | | | | | cold rolling | | |
| H | 0.0012 | 1.65 | 0.02 | 0.0008 | 0.07 | 0.0014 | 0.0018 | 0.04 | 0.038 | — | 0.0037 | Cracking during | | Comparative Example |
| | | | | | | | | | | | | hot rolling | | |
| I | 0.0019 | 1.58 | 1.23 | 0.0007 | 0.09 | 0.0021 | 0.0018 | 0.02 | 0.018 | — | 0.0028 | 2.98 | 1.731 | Example |
| J | 0.0014 | 1.60 | 3.32 | 0.0008 | 0.09 | 0.0020 | 0.0015 | 0.03 | 0.033 | 0.015 | 0.0031 | 2.61 | 1.695 | Comparative Example |
| K | 0.0025 | 1.63 | 0.48 | 0.0021 | 0.08 | 0.0017 | 0.0014 | 0.03 | 0.017 | 0.029 | 0.0028 | 3.45 | 1.737 | Example |
| L | 0.0016 | 1.62 | 0.46 | 0.0055 | 0.08 | 0.0016 | 0.0019 | 0.04 | 0.038 | — | 0.0027 | 4.62 | 1.710 | Comparative Example |
| M | 0.0019 | 1.71 | 0.51 | 0.0004 | 0.22 | 0.0012 | 0.0022 | 0.04 | 0.032 | — | 0.0028 | Cracking during | | Comparative Example |
| | | | | | | | | | | | | cold rolling | | |
| N | 0.0019 | 1.62 | 0.44 | 0.0012 | 0.09 | 0.0058 | 0.0023 | 0.04 | 0.035 | — | 0.0031 | 4.57 | 1.712 | Comparative Example |
| O | 0.0018 | 1.72 | 0.51 | 0.0011 | 0.07 | 0.0016 | 0.0055 | 0.02 | 0.036 | — | 0.0028 | 4.55 | 1.712 | Comparative Example |
| P | 0.0019 | 1.63 | 0.52 | 0.0008 | 0.08 | 0.0018 | 0.0022 | 0.04 | 0.037 | — | 0.0002 | 4.53 | 1.710 | Comparative Example |
| Q | 0.0017 | 1.59 | 0.48 | 0.0011 | 0.09 | 0.0015 | 0.0015 | 0.04 | 0.032 | — | 0.0041 | 3.47 | 1.738 | Example |
| R | 0.0021 | 1.55 | 0.38 | 0.0008 | 0.06 | 0.0021 | 0.0017 | 0.02 | — | — | 0.0027 | 3.43 | 1.720 | Example |
| S | 0.0019 | 1.61 | 0.42 | 0.0008 | 0.08 | 0.0015 | 0.0018 | 0.04 | — | 0.038 | 0.0033 | 3.40 | 1.737 | Example |
| T | 0.0022 | 1.58 | 0.39 | 0.0007 | 0.07 | 0.0016 | 0.0018 | 0.04 | 0.160 | — | 0.0029 | Cracking during | | Comparative Example |
| | | | | | | | | | | | | cold rolling | | |
| U | 0.0018 | 1.28 | 0.25 | 0.0010 | 0.08 | 0.0017 | 0.0015 | 0.02 | — | — | 0.0033 | 3.96 | 1.727 | Example |
| V | 0.0017 | 1.60 | 0.39 | 0.0011 | 0.03 | 0.0016 | 0.0017 | 0.03 | — | — | 0.0035 | 3.47 | 1.724 | Example |
| W | 0.0019 | 2.10 | 0.55 | 0.0006 | 0.08 | 0.0016 | 0.0016 | 0.03 | — | — | 0.0034 | 2.77 | 1.712 | Example |
| X | 0.0015 | 1.65 | 0.48 | 0.0042 | 0.09 | 0.0012 | 0.0013 | 0.03 | 0.044 | — | 0.0036 | 4.13 | 1.721 | Example |
| Y | 0.0019 | 2.11 | 0.51 | 0.0005 | 0.07 | 0.0018 | 0.0015 | 0.15 | 0.035 | — | 0.0035 | 3.31 | 1.699 | Comparative Example |
| Z | 0.0018 | 2.09 | 0.53 | 0.0002 | 0.06 | 0.0015 | 0.0017 | 0.07 | 0.043 | — | 0.0038 | 3.04 | 1.709 | Example |
| A2 | 0.0016 | 1.60 | 0.40 | 0.0002 | 0.09 | 0.0015 | 0.0016 | 0.03 | 0.039 | — | 0.0018 | 3.68 | 1.729 | Example |
| B2 | 0.0018 | 1.58 | 0.43 | 0.0003 | 0.08 | 0.0017 | 0.0018 | 0.03 | 0.041 | — | 0.0081 | 3.52 | 1.733 | Example |
| C2 | 0.0020 | 1.65 | 0.44 | 0.0003 | 0.10 | 0.0016 | 0.0021 | 0.04 | 0.034 | — | 0.0037 | 3.35 | 1.748 | Example |
| D2 | 0.0017 | 1.62 | 0.44 | 0.0007 | 0.01 | 0.0016 | 0.0017 | 0.04 | 0.037 | — | 0.0031 | 3.41 | 1.707 | Comparative Example |
| E2 | 0.0016 | 2.05 | 0.49 | 0.0004 | 0.05 | 0.0015 | 0.0014 | 0.13 | 0.040 | — | 0.0035 | 3.22 | 1.705 | Comparative Example |
| F2 | 0.0017 | 2.08 | 0.51 | 0.0003 | 0.06 | 0.0016 | 0.0015 | 0.09 | 0.044 | — | 0.0036 | 3.09 | 1.708 | Example |
| G2 | 0.0018 | 2.06 | 0.50 | 0.0002 | 0.06 | 0.0017 | 0.0016 | 0.06 | 0.041 | — | 0.0038 | 2.98 | 1.711 | Example |
| H2 | 0.0020 | 1.55 | 0.45 | 0.0004 | 0.06 | 0.0018 | 0.0018 | 0.04 | 0.038 | — | 0.0110 | 4.70 | 1.729 | Comparative Example |
| I2 | 0.0017 | 1.59 | 0.43 | 0.0002 | 0.07 | 0.0017 | 0.0017 | 0.03 | 0.043 | — | 0.0092 | 4.38 | 1.732 | Example |
| J2 | 0.0018 | 1.61 | 0.40 | 0.0005 | 0.08 | 0.0016 | 0.0016 | 0.03 | 0.038 | — | 0.0007 | 4.11 | 1.727 | Example |

As shown in Table 1, the steel samples manufactured according to the disclosure had no fracture in the hot rolling and cold rolling, and exhibited favorable magnetic property.

1. A non-oriented electrical steel sheet having a chemical composition containing, in mass %:
C: 0.0050% or less;
Si: 1.0% or more and 4.0% or less;
Mn: 0.10% or more and 3.0% or less;
Sol. Al: less than 0.0050%;
P: more than 0.01% and 0.20% or less;
S: 0.0050% or less;
N: 0.0050% or less;
Cu: 0.02% or more and less than 0.10%; and
Ca: 0.0005% or more and 0.0100% or less,
with a balance being Fe and incidental impurities.

2. The non-oriented electrical steel sheet according to claim 1,
wherein the chemical composition further contains one or two selected from Sn and Sb: 0.01 mass % or more and 0.1 mass % or less in total.

3. A manufacturing method of a non-oriented electrical steel sheet, comprising:
hot rolling a slab having a chemical composition containing, in mass %:
C: 0.0050% or less;
Si: 1.0% or more and 4.0% or less;
Mn: 0.10% or more and 3.0% or less;
Sol. Al: less than 0.0050%;
P: more than 0.01% and 0.20% or less;
S: 0.0050% or less;
N: 0.0050% or less;
Cu: 0.02% or more and less than 0.10%; and
Ca: 0.0005% or more and 0.0100% or less,
with a balance being Fe and incidental impurities;
pickling an obtained hot rolled sheet without annealing, and then cold rolling the sheet; and
final annealing the cold rolled sheet,
wherein after finish rolling in the hot rolling, the hot rolled sheet is coiled at a temperature of 650° C. or more.

4. The manufacturing method of a non-oriented electrical steel sheet according to claim 3,
wherein the chemical composition further contains one or two selected from Sn and Sb: 0.01 mass % or more and 0.1 mass % or less in total.
